(19) United States
(12) Patent Application Publication
(10) Pub. No.: US 2009/0139414 A1
(43) Pub. Date: Jun. 4, 2009

(54) Decorator Carriage Cam Follower Slide

(75) Inventor: Patrick L. Sullivan, Federal Way, WA (US)

Correspondence Address: SHERIDAN ROSS PC, 1560 BROADWAY, SUITE 1200, DENVER, CO, 80202, US

(73) Assignee: Ball Corporation, Broomfield, CO (US)

(21) Appl. No.: 11/949,648

(22) Filed: Dec. 3, 2007

(51) Int. Cl. B41F 17/00

(52) U.S. Cl. 101/35

(57) ABSTRACT

An improved method of supporting a portion of an inker apparatus is provided. More specifically, a system for interfacing with cam followers that are interconnected to a carriage bed of the inker apparatus is contemplated wherein wear to the cam follower is eliminated by providing a surface for engagement to a replaceable slide bearing. By employing this combination, down time, spoilage and costs are reduced.

This application is related to pending U.S. patent application Ser. No. 11/331,941, filed Jan. 13, 2006, U.S. Published Patent Application No. 2007/0169647, entitled “Servomechanical Inker for a Container Decorator”, the entire disclosure of which is incorporated by reference herein.

### FIELD OF THE INVENTION

The present invention relates to an inking apparatus for applying indicia to a container. More specifically, embodiments of the present invention include a carriage plate that supports a portion of the inking apparatus wherein the carriage plate is supported by a plurality of cam followers that are integrated to sliding blocks.

### BACKGROUND OF THE INVENTION

Automated container decorating apparatus are employed to apply indicia, such as artwork, designs, trademarks, etc. onto a container, such as a metallic beverage can. An apparatus indicative of the state of the art is disclosed in U.S. Pat. No. 6,651,552 to Didonato (“Didonato”), which is incorporated by reference in its entirety herein. Didonato includes an infeed that directs containers onto a spindle disc that includes a plurality of mandrels extending therefrom that receive the containers and allows them to rotate relative to the spindle disc. A print section, defined by a bull gear and a blanket cylinder, rotates on an axis substantially parallel to the axis of rotation of the spindle disc. The bull gear and the blanket cylinder are situated along the same rotational axis but are spaced a predetermined distance from each other. As the bull gear rotates, a plurality of pinion gears engaged therewith are rotated that each rotate a shaft. The shafts interconnected to the pinion gears are also interconnected to inker station gears that mechanically communicate with an inker station. The terminal end of the shaft is interconnected to a cylinder that includes a plate positioned therearound.

As the bull gear rotates, the individual pinion gears rotate their individual shafts, thereby rotating the inker station gears and the plate cylinders. The rotating inker station gears rotate additional gears positioned in the inker station that are interconnected to a plurality of rollers that facilitate the transfer of ink from a reservoir of the inker station onto the plate that is situated on the cylinder. As the cylinder rotates, it contacts a blanket that is positioned around the blanket cylinder, thereby depositing ink in a predetermined pattern thereon. Inker apparatus generally include a plurality of inker stations that each place a separate, colored pattern onto a portion of the blanket. As the blanket cylinder rotates, the individual inked portions of the blanket engage the containers positioned on the mandrels to deposit a multi-colored design on each container. After the individual containers have been inked, they are directed to a varnisher, oven, etc. and expelled from the apparatus to be directed to another location in the facility.

Currently, a portion of the inker apparatus is supported by a carriage plate. The carriage plate is adjustable with respect to the adjacent print station of the inker apparatus. During production, the elevation of the carriage plate is often altered whereby the indicia imparted on the containers is less than ideal. More specifically, an elevation change is caused as the carriage plate settles, which increases the pressure applied by the inking blanket of the print station onto the containers. The increased pressure thus influences the quality of the indicia being applied.

Often, the carriage plate is supported by a plurality of cam followers, i.e. shafts, that provide load points that engage a base that is shared with the print station. A wear plate is also included that is located between the cam followers and the base. As used herein, a “cam follower” is defined as a rolling element needle bearing with an integral stud for mounting. Motion related to the internal workings of the inker apparatus causes the cam followers to move laterally with respect to the stationary wear plate wherein movements of less than about 0.20 inches are common. The heavy load of the inker apparatus is, thus, concentrated on a small area which causes the wear plate to thin. As a result, the container feed portion of the inker apparatus settles with respect to the stationary print station, thereby affecting the print quality. In order to correct these anomalies, the inker assembly must be shut down and taken off line for about 4 to 5 hours wherein the wear plate, and often the cam followers, must be replaced. Thereafter, the entire inker apparatus must be recalibrated. This process delays production, which wastes time and money. In addition, during the recalibration phase, a plurality of containers must be fed through the inker apparatus to ensure that the desired indicia is correctly placed on the container at a desired quality, thus creating further waste.

Thus there is a long felt need in the field of container production to provide an inking apparatus that reduces waste, equipment downtime and associated maintenance. The following disclosure describes an improved inking apparatus that employs a plurality of wear blocks that are interconnected to the cam followers to reduce wear, thereby increasing the life of the cam followers and operational efficiency.

### SUMMARY OF THE INVENTION

It is one aspect of the present invention to provide an inker apparatus that replaces the current configuration of employing a cam follower that engages the wear plate with a cam follower that is engaged within a carriage slide that interacts with an easily replaceable slide bearing. More specifically, embodiments of the present invention employ a decorator carriage slide that is a precision fit onto the cam follower, thus protecting the cam follower from wear. The decorator carriage slide has a substantially planar and polished bottom surface that engages a slide bearing that is interconnected to the base of the inker assembly. During normal operations, the carriage, as described above, moves laterally, thereby taking along with it the cam follower and the decorator carriage slide. The decorator carriage slide spreads the load onto the slide bearing. After the slide bearing is worn away a predetermined amount, the inker apparatus is taken off line and the carriage assembly is moved upwardly. Bolts and a retainer plate that hold the slide bearing are then removed and the slide bearing is replaced. The carriage is then lowered into its operating position wherein the bottom portion of the decorator carriage slide engages with the slide bearing. This position is the ideal position for printing and as such no further calibration is needed. Thus embodiments of the present invention eliminate wear on the cam follower and wear plate of a container inker apparatus.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a plan view of a container inker assembly;

FIG. 2 is a detailed view of FIG. 1 showing a cam follower and wear plate combination of the prior art;

FIG. 3 is a detailed view of FIG. 1 showing a cam follower and slider of one embodiment of the present invention;

FIG. 4 is a perspective view of a slider assembly of one embodiment of the present invention;

FIG. 5 is an exploded view of the slider assembly;

FIG. 6 is a front elevation view of a decorator carriage slide of one embodiment of the present invention;

FIG. 7 is a right elevation view of the decorator carriage slide shown in FIG. 6;

FIG. 8 is a top plan view of a slide bearing of one embodiment of the present invention;

FIG. 9 is a front elevation view of the slide bearing shown in FIG. 8;

FIG. 10 is a top plan view of a retainer plate of one embodiment of the present invention; and

FIG. 11 is a front elevation view of the retainer plate shown in FIG. 10.

To assist in the understanding of the present invention the following list of components and associated numbering found in the drawings is provided herein:

# Component

2 Container inker apparatus

6 Container feed portion

10 Print station

14 Container

18 Base

22 Carriage plate

26 Cam follower

30 Wear plate

34 Blanket

38 Decorator carriage slide

42 Slide bearing

46 Bore hole

50 Retainer plate

54 Bolt

58 Washer

62 Tapped hole

66 Plug

70 Hole

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

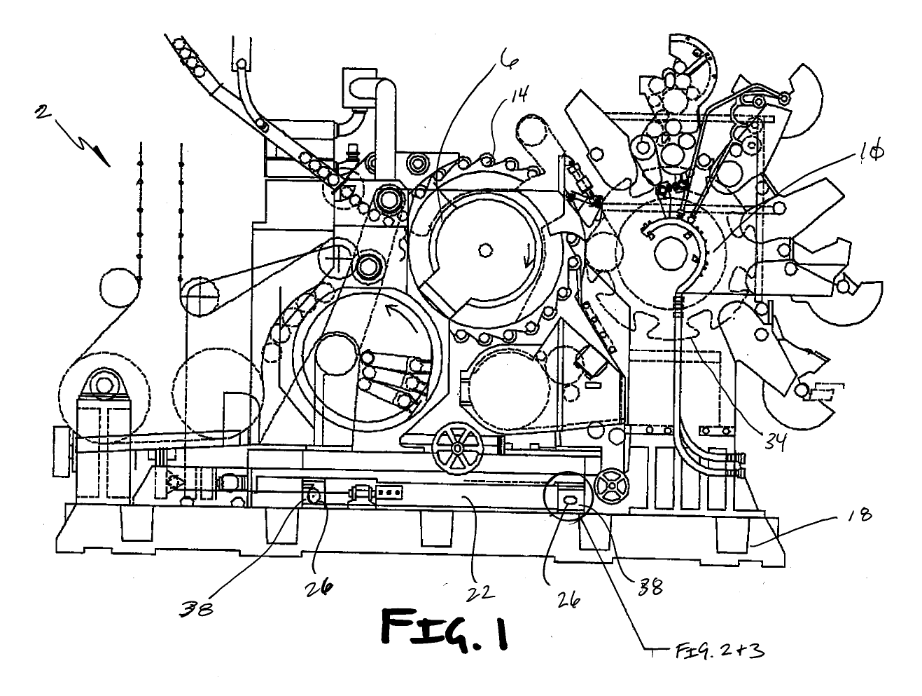

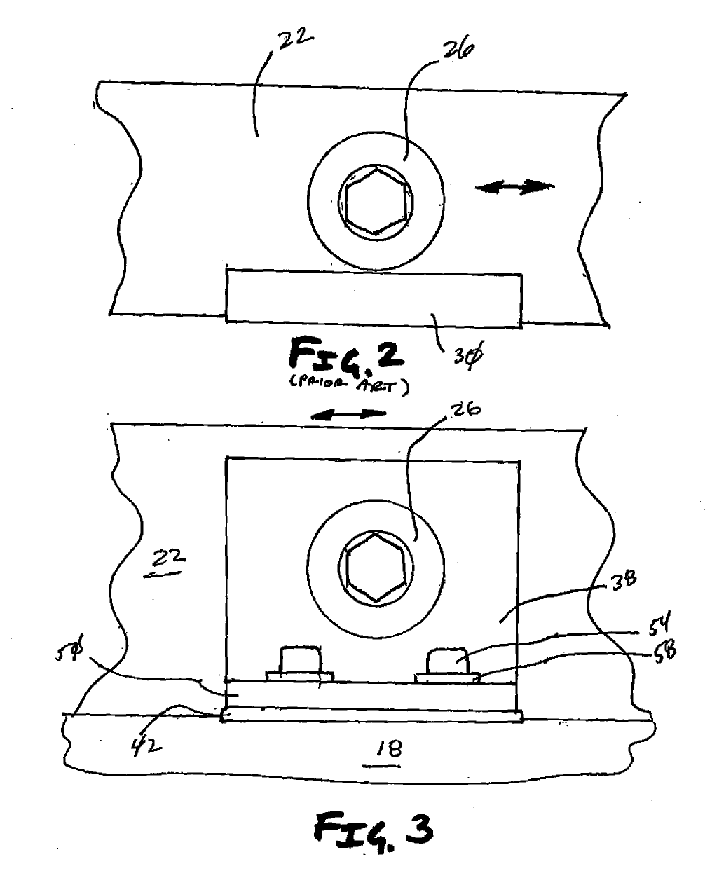

Referring now to FIGS. 1 and 2, an inker apparatus 2 of one embodiment of an inking apparatus 2 commonly used in the art along with the prior art method of supporting a container feed portion 6 is shown. In operation, the inker apparatus 2 includes a container feed portion 6 that feeds containers 14 adjacent to a plurality of print stations 10 wherein indicia is applied by an inked blanket. Thereafter, the feed portion 6 retrieves the inked containers 14 and transfers them to a conveyor belt for drying. The feed portion 6 of the inker apparatus 2 is interconnected to a base 18 that is interconnected to a carriage plate 22 that includes a plurality of cam followers 26. The cam followers 26 of one embodiment are generally comprised of a shaft that rests on a wear plate 30 that is interconnected to the base 18 of the inker apparatus 2. The bulk of the container feed portion 6 rests on the movable carriage plate 22 such that minute adjustments may be made to alter the spacial relationship between the container feed portion 6 and the print station 10 of the inker apparatus 2, which dictate the amount of ink applied to a container. In operation, the carriage plate 22 will move relative to the print station, often about 0.2 inches left to right. Thus the cam follower 26 transfers a great amount of weight onto a small area of the wear plate 30, thereby reducing the height of the wear plate 30 by wearing both the cam follower 26 and the wear plate 30. As wearing continues, one skilled in the art will appreciate that the container feed portion 6 of the inker apparatus will move downwardly, i.e. settle, which increases the pressure applied by a blanket 34 that has been applied with a plurality of inks onto the containers 14, thereby blurring the applied image. When this situation occurs, operators shut down the inker apparatus 2 and to replace the wear plate 30 and the cam follower 26.

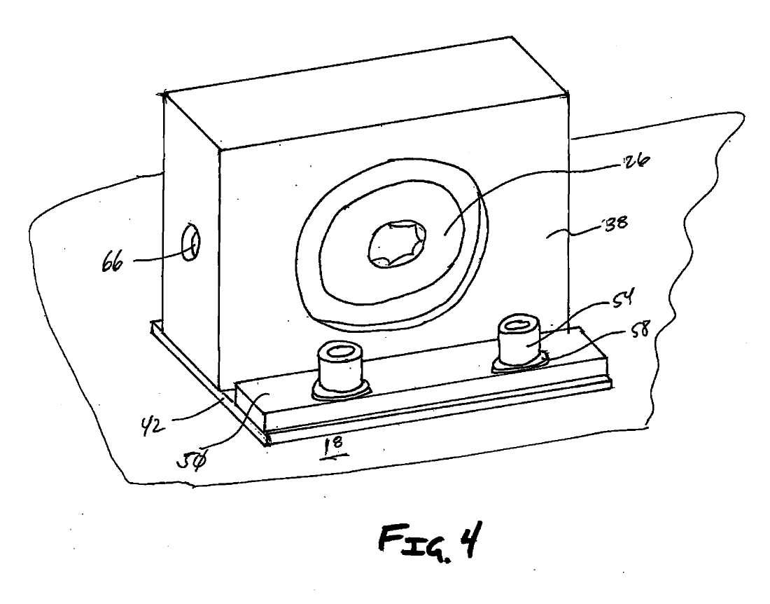

Referring now to FIGS. 3-11, one embodiment of the present invention is shown that includes a decorator carriage slide 38 that interconnects to the cam follower 26 and which selectively engages a slide bearing 42. More specifically, embodiments of the present invention provide a decorator carriage slide 38 that includes a bore hole 46 that receives the cylindrical cam follower 26. The decorator carriage slide 38 engages a slide bearing 42, preferably, with a film therebetween. The slide bearing 42 is held in place by a retainer plate 50 that utilizes a plurality of bolts 54 and washers 58 to secure the slide bearing 42 onto the base of the inker apparatus.

Referring now specifically to FIGS. 3-5, one embodiment of the present invention is shown wherein the decorator carriage slide 38 includes a substantially circular bore hole 46 through a front face thereof that receives the cam follower. The decorator carriage slide 38 also includes a plurality of tapped holes 62, preferably integrated onto the left and right sides of the decorator carriage slide 38 that receive plugs 66. In operation, after the cam followers 26 are inserted into the bore hole 46, the plugs 66 are engaged into the tapped holes 62 of the decorator carriage slide 38 to substantially prevent rotation of the decorator carriage slide 30. The cam follower rests on a slide bearing that includes a plurality of through holes 70. The retainer plate 50 also includes a plurality of holes 70, is placed atop the slide bearing 42 and the plurality of bolts 54 and washers 58 are used to interconnect the assembly to the base of the inker apparatus. Thus when the cam follower 26 transitions laterally it is not worn. Alternatively, the decorator carriage slide 38 and/or the slide bearing 42 is worn. Preferably, the slide bearing 42 is the only component that wears as a result of the friction created between the decorator carriage slide 38 and the slide bearing 42 since it is designed to be softer than the decorator carriage slide 38.

To replace the slide bearing 42, the container feed portion of the inker is lifted, and the bolts 54 and washers 58 are removed to allow removal of the slide bearing 42. Once the slide bearing 42 is replaced and the bolts 54, washers 58 and retaining plate 50 are replaced, the container feed portion of the inker assembly is lowered such that the decorator carriage slide 38 contacts the slide bearing 42. Since the slide bearing 42 is of a predetermined height, adjustments after replacement of the slide bearing 42 are minimized.

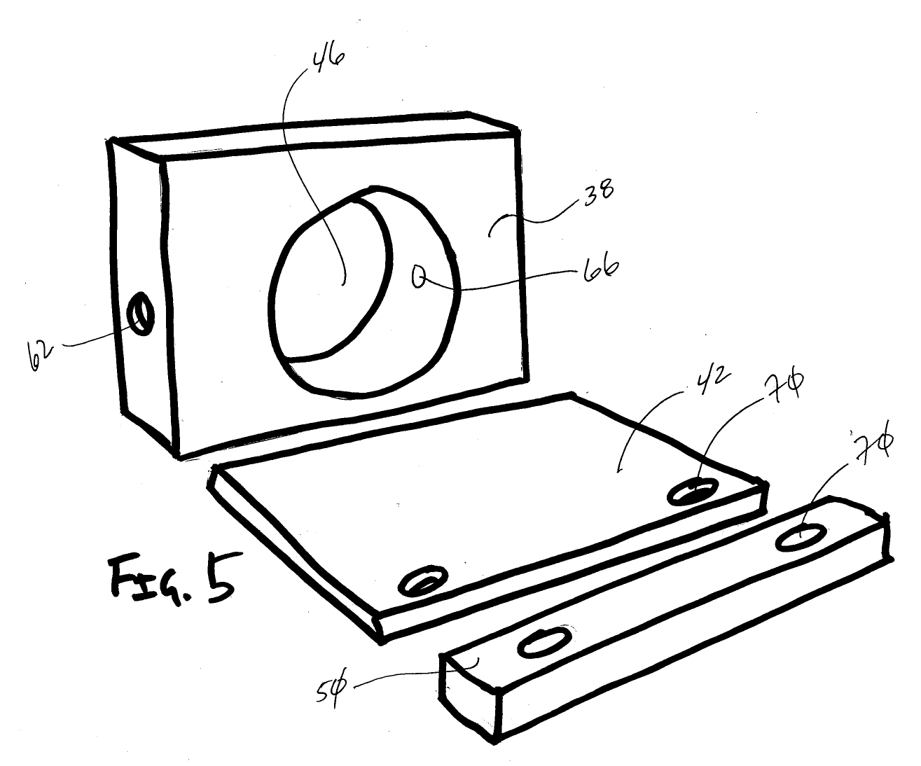

Referring now to FIGS. 6 and 7, a decorator carriage slide 38 of one embodiment of the present invention is shown. Preferably, the decorator carriage slide 38 is made of a hard and durable material, preferably 4140 steel. One skilled in the art, however, will appreciate that other materials may be used, such as aluminum. Embodiments of the present invention employ a generally rectangular decorator carriage slide 38 having a width of about 6 inches, a height of about 4 inches and a thickness of about 2 inches. The bore hole 46 employed has a diameter of about 3 inches and is located equidistant from the left and right sides of the decorator carriage slide 38 and about 1.803 inches from the base of the decorator carriage slide 38. The decorator carriage slide 38 may include rounded corners with a ⅛ inch radius and its bottom surface may include a polished surface to Ra-8 micro inches (10-6 inches). The tapped holes 62 are also positioned about 1.803 inches from the base of the decorator carriage slide 38 and have a diameter of about ½ inch diameter with a number 13 thread. The tapped holes 42 receive, preferably, brass plugs with dimensions of ½ inch diameter by number 13 thread by ½ long. Set screws (not shown) are adapted to then be placed with the tapped hole 62 wherein tightening of the set screws move the plugs 66 into the bore hole 46 for engagement with the cam follower 26.

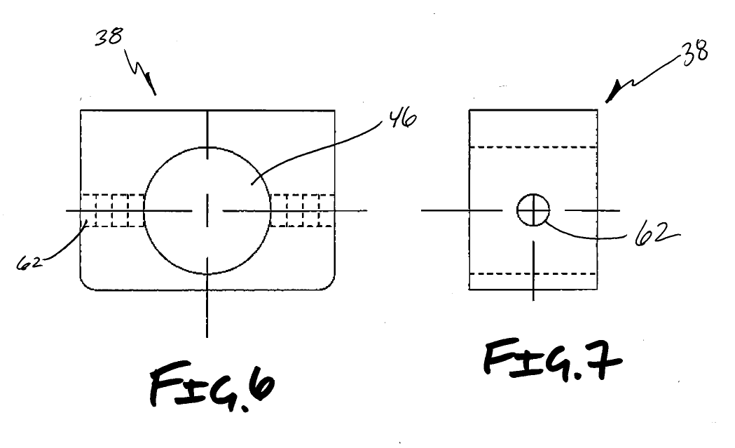

Referring now to FIGS. 8 and 9, the slide bearing 42 of one embodiment of the present invention is shown that is about three inches deep ¼ inch thick and about 6 inches wide. The holes 70 provided by the slide bearing 42 of embodiments of the present invention are about 7/32 inch diameter and are located 1.125 inches from the left and right edges and about 0.540 inches from the front surface of the slide bearing 42. Preferably, the slide bearing is manufactured of an extruded or compression molded thermoplastic, such as TORLON®, poly-amide. Embodiments of the present invention employ TORLON® 5030 manufactured by Drake Plastics, Cypress, Tex.

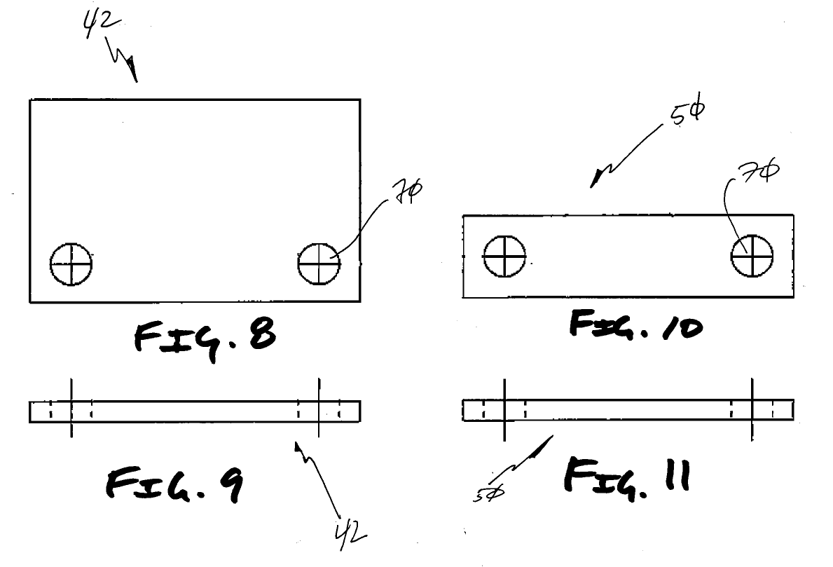

Referring now to FIGS. 10 and 11, the retainer plate 50 employed by embodiments of the present invention is shown. Preferably, the retainer plate 50 is about 0.875 inches deep, about 6 inches wide and about ¼ inch thick. The holes 70 of the retainer plate 50 are about 7/32 inches in diameter and are located about 0.437 inches from the front face of the retainer plate 50 and 1.125 inches from the left and right surfaces of the retainer plate 50. Preferably, the retainer plate 50 is constructed of a stiff material such as cold rolled steel. One skilled in the art will appreciate that any stiff material may be used. In addition, one skilled in the art will appreciate that the retainer plate 50 may be omitted wherein the slide bearing 42 is interconnected directly to the base of the inker apparatus.

Referring now to FIGS. 3-11, embodiments of the present invention, as described above, are constructed of common materials. One skilled in the art will appreciate that the materials listed herein should not limit this disclosure. The shape of the decorator carriage slide 38 may also be altered to receive a square shaft instead of a generally circular shaft as well.

Referring now to FIGS. 1-11, one method of installing a decorator carriage slide 38 is provided herein. This method of replacing a decorator carriage slide 38 should be viewed with respect to the inker assembly manufactured by Stolle Machinery Company, LLC, Centennial, Colo. Initially, the inker apparatus 2 is taken off line wherein the print station 10 is locked out. Then, a triangular cam follower rotation lock is removed. The carriage bed is raised to allow about one inch clearance between the cam follower 26 and the wear plate 30. Next, the wear plate 30 is removed. The outside surface and the surface beneath the wear plate 30 are then cleaned and the decorator carriage slide 38 is positioned onto the cam follower 26. Preferably a material, such as loctite 242 is applied to each of the set screws and the plugs 66 are inserted into the tapped holes 62 followed by the set screws (not shown). The set screws are screwed into the decorator carriage slide 38 which causes the plugs 66 to tighten against the cam follower 26. Next, a thin coat of CMD extreme pressure lube no. 3 is applied to the upper surface of the slide bearing 42 where the decorator carriage slide 38 will contact the slide bearing 42. Loctite 242 is then applied to the bolts 54 that interconnect the retaining plate 50 to the slide bearing 42 to the base 18. The bolts 54 are then tightened. The carriage 22 is then lowered such that the decorator carriage slide 38 engages with the slide bearing 42.

After installation, the carriage 22 is tripped in and out about 6-8 times. Thereafter, a grease fitting is removed from the cam follower eccentric lock bolt head and the eccentric lock bolt nut is loosened. These steps are taken to adjust the carriage 22 to the correct height. After the carriage 22 has achieved its correct height, a locking bolt and a locking nut are tightened and a grease fitting is installed into the head of the bolt. Finally, the triangular cam follower rotational lock is installed. One skilled in the art will appreciate that theses steps are presented for example purposes only. Other methods may be used to replace the normal cam follower/wear plate combination with the embodiments of the present invention contemplated herein.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A container inking apparatus, comprising:
a base;
a print station interconnected to said base;
a container feed portion selectively interconnected to said base and operably spaced from said print station such that containers located in said container feed portion are positioned adjacent to said print station to deposit indicia on the containers;
a carriage plate positioned above said base having a plurality of shafts extending therefrom that are operably interconnected to said container feed station that allow said container feed portion to move laterally;
a carriage slide interconnected to each of said shafts; and
a slide bearing interconnected to said base that has an upper surface that slidingly engages said carriage slide, wherein said carriage slide moves upon said slide bearing.

2. The apparatus of claim 1, wherein said plurality of shafts are cylindrical and said carriage slide includes a bore through a face thereof and tapped holes extending into the sides thereof into said bore, and wherein said shafts are placed into said bore and held in place with plugs that are positioned in said tapped holes.

3. The apparatus of claim 1, further including a lubricant positioned between said carriage slide and said slide bearing.

4. The apparatus of claim 1, wherein said slide bearing is interconnected to said base with a retaining plate that is interconnected to said base with at least one fastener.

5. The apparatus of claim 1, wherein said slide bearing is made of compression molded thermoplastic.

6. A slider assembly adapted for interconnection to a cam shaft of a container inker assembly, comprising:
a carriage slide having a front side, a back side and lateral sides extending therebetween;
a bore extending from said front side to said back side, said bore adapted to receive the cam shaft;
a bearing for sliding engagement with said slide;
a plate operably engaged to an upper portion of said bearing that retains said bearing in a predetermined position; and
wherein when said carriage slide moves relative to said bearing said bearing wears.

7. The assembly of claim 6, further including lubrication between said slide and said bearing.

8. The assembly of claim 6, wherein said slide includes tapped holes integrated into said lateral sides and wherein said cam shaft is held in place with plugs that are positioned in said tapped holes.

9. The assembly of claim 6, wherein said slider bearing is made of compression molded thermoplastic.

10. The assembly of claim 6, wherein said cam shaft is interconnected to a container feed portion of an inker apparatus.

11. A container inking apparatus, comprising:
a means for supporting;
a means for printing interconnected to said means for supporting;
a means for feeding containers selectively interconnected to said means for supporting and operably spaced from said means for printing such that containers located in said means for feeding containers are positioned adjacent to said means for printing to deposit indicia on the containers;
a movable plate positioned above said means for supporting having a plurality of members extending therefrom that are operably interconnected to said means for feeding containers that allow lateral movement thereof;
a means for spacing interconnected to each of said members; and
a means for supporting a moving member associated with said means for supporting that has an upper surface that slidingly engages said means for spacing.

12. The apparatus of claim 11, wherein said plurality of members are cylindrical and said movable plate includes a bore through a face thereof and tapped holes extending into the sides thereof into said bore, and wherein said members are placed into said bore and held in place with securing means that are positioned in said tapped holes.

13. The apparatus of claim 11, further including a friction reducing means positioned between said movable plate and said means for supporting a moving member.

14. The apparatus of claim 11, wherein said means for supporting a moving member is interconnected to said means for supporting with a plate that is interconnected to said means for supporting with at least one means for attaching.

15. The apparatus of claim 11, wherein said means for supporting a moving member is made of compression molded thermoplastic.
